(19) United States
(12) Patent Application Publication
(10) Pub. No.: US 2024/0330770 A1
(43) Pub. Date: Oct. 3, 2024

(54) DATA PROCESSING METHOD, DEVICE AND STORAGE MEDIUM

(71) Applicant: BEIJING VOLCANO ENGINE TECHNOLOGY CO., LTD., Beijing (CN)

(72) Inventor: Li XU, Beijing (CN)

(21) Appl. No.: 18/617,557

(22) Filed: Mar. 26, 2024

(30) Foreign Application Priority Data
Mar. 28, 2023 (CN) 202310315396.8

(51) Int. Cl. G06N 20/00

(52) U.S. Cl. CPC G06N 20/00

(57) ABSTRACT

Embodiments of the present disclosure provide a data processing method, device and storage medium, by obtaining time series data of multiple indicators for which causal relationship is to be analyzed; clustering the multiple indicators according to probability distributions of the time series data of the multiple indicators; analyzing causal connection relationships and connection directions between each of the indicators based on clustering result to construct a causal relationship network structure; obtaining conditional probability tables of each of the indicator nodes in the causal relationship network structure according to the time series data of the multiple indicators; and obtaining Bayes Belief Networks according to the causal relationship network structure and the conditional probability tables of each of the indicator nodes, to represent the causal relationships between each of the indicators.

### CROSS-REFERENCE TO RELATED APPLICATIONS

This application claims priority to Chinese patent application No. 202310315396.8 filed on Mar. 28, 2023, with the Chinese Patent Office, the entire content of which is incorporated into this application by reference.

### TECHNICAL FIELD

Embodiments of the present disclosure relate to the field of computer and network communication technologies, and in particular, to a data processing method, device and storage medium.

### BACKGROUND

Causal relationship identification is a challenging relationship identification task in natural language processing and has attracted increasing attention in the field of natural language processing.

In existing technologies, a Granger causality model is usually used to discover causal characteristics of time series data to reveal the Granger causal relationship behind multivariate time series data. However, the Granger causality model usually can only be used to detect the causal relationship between two indicators. When facing high-dimensional time series data of multiple indicators, it has high calculation cost and limited processing power.

### SUMMARY

Embodiments of the present disclosure provide a data processing method, device and storage medium to reduce the cost and improve efficiency for discovering causal relationships of high-dimensional time series data of multiple indicators.

In a first aspect, an embodiment of the present disclosure provides a data processing method, comprising:
obtaining time series data of multiple indicators, for which causal relationship is to be analyzed;
clustering the multiple indicators according to probability distributions of the time series data of the multiple indicators, wherein indicators of the same category are indicators of independent identically distribution;
analyzing causal connection relationships and connection directions between each of the indicators based on clustering result, and constructing a causal relationship network structure, the causal relationship network structure including indicator nodes and directed edges connecting the indicator nodes, the directed edges being used to represent causal relationships between connected indicator nodes;
obtaining conditional probability tables of each of the indicator nodes in the causal relationship network structure according to the time series data of the multiple indicators;
obtaining Bayes Belief Networks, according to the causal relationship network structure and the conditional probability tables of each of the indicator nodes, to represent the causal relationships between each of the indicators.

In a second aspect, an embodiment of the present disclosure provides a data processing device, comprising:
a time series data obtaining unit for obtaining time series data of multiple indicators, for which causal relationship is to be analyzed;
a clustering unit for clustering the multiple indicators according to probability distributions of the time series data of the multiple indicators, wherein indicators of the same category are indicators of independent identically distribution;
a causal structure learning unit for analyzing causal connection relationships and connection directions between each of the indicators based on clustering result, and constructing a causal relationship network structure, the causal relationship network structure including indicator nodes and directed edges connecting the indicator nodes, the directed edges being used to represent causal relationships between connected indicator nodes;
a conditional probability table learning unit for obtaining conditional probability tables of each of the indicator nodes in the causal relationship network structure according to the time series data of the multiple indicators;
a model generation unit for obtaining Bayes Belief Networks according to the causal relationship network structure and the conditional probability tables of each of the indicator nodes, to represent the causal relationships between each of the indicators.

In a third aspect, an embodiment of the present disclosure provides an electronic device, comprising: at least one processor and a memory;
the memory having computer executable instructions stored thereon;
the at least one processor executing the computer executable instructions stored in the memory, causing the at least one processor to execute the data processing method according to the above first aspect and various possible designs of the first aspect.

In a fourth aspect, an embodiment of the present disclosure provides a computer-readable storage medium having computer executable instructions stored thereon, which, when executed by a processor, implement the data processing method according to the above first aspect and various possible designs of the first aspect.

In a fifth aspect, an embodiment of the present disclosure provides a computer program product including computer executable instructions, which, when executed by a processor, implement the data processing method according to the above first aspect and various possible designs of the first aspect.

The data processing method, device and storage medium provided by the embodiments of the present disclosure, by means of obtaining time series data of multiple indicators for which causal relationship is to be analyzed; clustering the multiple indicators according to probability distributions of the time series data of the multiple indicators, wherein indicators of the same category are indicators of independent identically distribution; analyzing causal connection relationships and connection directions between each of the indicators based on clustering result, and constructing a causal relationship network structure, the causal relationship network structure including indicator nodes and directed edges connecting the indicator nodes, the directed edges being used to represent causal relationships between connected indicator nodes; obtaining conditional probability tables of each of the indicator nodes in the causal relationship network structure according to the time series data of the multiple indicators; and obtaining Bayes Belief Networks, according to the causal relationship network structure and the conditional probability tables of each of the indicator nodes, to represent the causal relationships between each of the indicators.

### BRIEF DESCRIPTION OF THE DRAWINGS

In order to more clearly illustrate the embodiments of the present disclosure or technical solutions in the related art, a brief introduction will be made below to the drawings that need to be used in the description of the embodiments or the related art. Obviously, the drawings in the following description are some embodiments of the present disclosure. For those of ordinary skill in the art, other drawings can be obtained in view of these drawings without exerting any creative effort.

FIG. 1 is a scene example diagram of a data processing method provided by an embodiment of the present disclosure;

FIG. 2 is a schematic flow chart of a data processing method provided by an embodiment of the present disclosure;

FIG. 3 is a schematic flowchart of a data processing method provided by another embodiment of the present disclosure;

FIG. 4 is a schematic diagram of a system architecture of a data processing method provided by an embodiment of the present disclosure;

FIG. 5 is a structural block diagram of a data processing device provided by an embodiment of the present disclosure;

FIG. 6 is a structural block diagram of a data processing device provided by another embodiment of the present disclosure;

FIG. 7 is a schematic diagram of a hardware structure of an electronic device provided by an embodiment of the present disclosure.

### DETAILED DESCRIPTION

In order to make the purpose, technical solutions and advantages of the embodiments of the present disclosure clearer, the technical solutions in the embodiments of the present disclosure will be clearly and completely described below in conjunction with the drawings in the embodiments of the present disclosure. Obviously, the embodiments described are part, not all, of the embodiments of the present disclosure. Based on the embodiments in this disclosure, all other embodiments obtained by those of ordinary skill in the art without making creative efforts fall within the claimed scope of this disclosure.

In existing technologies, a Granger causality model is usually used to discover causal characteristics of time series data to reveal the Granger causal relationship behind multivariate time series data. However, the Granger causality model usually can only be used to detect the causal relationship between two indicators. When facing high-dimensional time series data of multiple indicators, it has high calculation cost and limited processing power.

In order to solve the above technical problems, the present disclosure provides a data processing method, by means of obtaining time series data of multiple indicators for which causal relationship is to be analyzed; clustering the multiple indicators according to probability distributions of the time series data of the multiple indicators, wherein indicators of the same category are indicators of independent identically distribution; analyzing causal connection relationships and connection directions between each of the indicators based on clustering result, and constructing a causal relationship network structure, the causal relationship network structure including indicator nodes and directed edges connecting the indicator nodes, the directed edges being used to represent causal relationships between connected indicator nodes; obtaining conditional probability tables of each of the indicator nodes in the causal relationship network structure according to the time series data of the multiple indicators; and obtaining Bayes Belief Networks, according to the causal relationship network structure and the conditional probability tables of each of the indicator nodes, to represent the causal relationships between each of the indicators. The present disclosure can perform causal relationship discovery on high-dimensional time series data of multiple indicators, greatly improve dimensions of the time series data that can be processed in the causal relationship discovery process, expand applicable scenarios for causal relationship discovery, and reduce computing costs through dimensionality reduction by clustering, improve the efficiency of causal relationship discovery, and provide auxiliary information support for decision-making or fault root cause location in application scenarios such as network services.

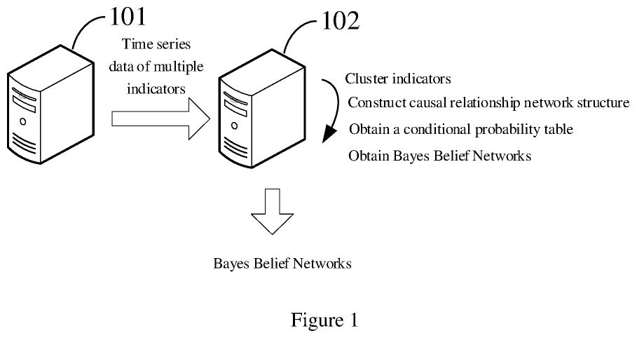

The present disclosure provides a data processing method applicable for the application scenario shown in FIG. 1, including a data collection system 101 and a data processing device 102, wherein the data collection system 101 can obtain time series data of multiple indicators for which causal relationship is to be analyzed, and send it to the data processing device 102 for executing the data processing method described above, and finally obtaining Bayes Belief Networks to represent the causal relationships between each of the indicators.

The data processing method of the present disclosure will be introduced in detail below with reference to specific embodiments.

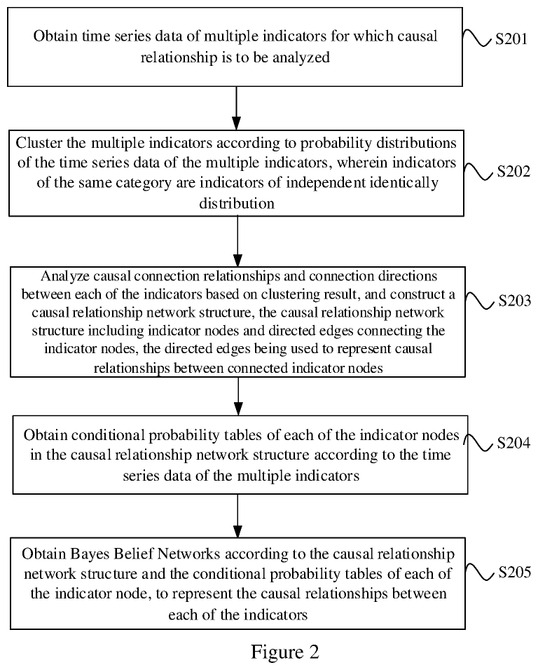

Referring to FIG. 2, which is a schematic flowchart of a data processing method provided by an embodiment of the present disclosure. The method of this embodiment can be applied in terminal devices or servers. The data processing method comprises:

S201. obtaining time series data of multiple indicators for which causal relationship is to be analyzed.

In this embodiment, the multiple indicators for which causal relationship is to be analyzed can be determined according to specific application scenarios, for example, causal relationships of indicators such as user concurrency of s network service, memory usage of a server, CPU usage etc, then obtaining time series data of the user concurrency of the network service, the memory usage of the server, and the CPU usage respectively. Optionally, time series data of multiple indicators can be obtained from a third-party data collection system.

S202. clustering the multiple indicators according to probability distributions of the time series data of the multiple indicators, wherein indicators of the same category are indicators of independent identically distribution.

In this embodiment, since the multiple indicators may be massive indicators, in order to eliminate indicators with no causal correlation or weak correlation from the multiple indicators and find a set of indicators with strong correlation, the multiple indicators can be clustered according to the time series data of the multiple indicators, in which indicators of the same category are indicators of Independent Identically Distribution (i.i.d), that is, clustering is performed according to probability distributions of the indicators. For example, indicators with normal distribution are clustered into one category, and indicators with beta distribution are clustered into one category. Indicators with the same or similar probability distributions have a strong correlation and may have a causal relationship, while indicators with different or dissimilar probability distributions have a weak correlation and may not have a causal relationship.

Optionally, in this embodiment, any clustering algorithm can be used to cluster the multiple indicators. Among the clustering algorithms, commonly used clustering algorithms can be divided into Hierarchical clustering methods (also called hierarchical-based clustering) and Partition clustering methods (also called partition-based clustering algorithms), wherein the hierarchical clustering algorithm reveals hierarchical structure of data, and forms a tree-shaped clustering structure by dividing at different levels; the partition clustering algorithm divides multiple object sets into different categories that are mutually exclusive, each object belonging to and only belonging to one category; in this embodiment, a partition clustering algorithm can be used, the principle of which is to calculate distances between each of the indicator (usually using Euclidean distance, Dynamic Time Warping, etc.) based on time series data of the multiple indicators, and divide the indicators into multiple sets according to the distances. The clustering result can be represented and stored using an adjacency matrix including correlation coefficients between each of the indicators, which represents the correlations between each of the indicators on the probability distribution. According to the adjacency matrix, it can be determined whether any two indicators belong to the same category.

Optionally, the clustering algorithms in this embodiment include Kmeans, DBSCAN, and OPTICS, which are all based on the maximum attainable density theory in principle.

Optionally, the clustering of multiple indicators in this embodiment belongs to high-dimensional data clustering. For high-dimensional data, a non-parametric Bayesian clustering method can be used, such as a Chinese Restaurant Process (CRP) based on the Dirichlet process and its derivative methods. The multiple indicators are clustered according to their time series data, and an adjacency matrix is output as the final result, which can quickly find similar correlations in the high-dimensional time series data.

S203. analyzing causal connection relationships and connection directions between each of the indicators based on the clustering result, and constructing a causal relationship network structure, the causal relationship network structure including indicator nodes and directed edges connecting the indicator nodes, the directed edges being used to represent causal relationships between connected indicator nodes.

In this embodiment, a score-based structure learning algorithm can be applied for learning of the causal relationship network structure. Specifically, based on the cluster analysis result, the causal connection relationships and connection directions between indicators can be analyzed, for example, through a conditional independence testing method (such as d/m-separation method) to find and verify the correlations between the indicators, and through a V-structure and Meek rules methods to determine the connection directions in the causal connection relationships between each of the indicators.

Furthermore, a causal relationship network structure is constructed according to the connection relationships and the connection directions by using the indicators as nodes, wherein the causal relationship network structure uses the indicators as nodes and the causal relationships as directed edges, wherein the causal relationship network structure can be Directed Acyclic Graph (DAG) or Maximal Ancestral Graph (MAG), in which the indicator nodes with connection relationships indicate existence of causal relationships between the indicators. The indicator nodes are connected by directed edges, while the connection direction indicates which indicator of the indicator nodes connected by the directed edge is the cause and which indicator is the effect.

S204. obtaining conditional probability tables of each of the indicator nodes in the causal relationship network structure according to the time series data of the multiple indicators.

In this embodiment, the indicator nodes in the causal relationship network structure indicate the existence of causal relationships through directed edge connections, but cannot indicate strength of the connection relationships. Therefore, the Conditional Probability Tables (CPTs) of each of the indicator nodes in the causal relationship network structure can be obtained, to facilitate subsequently indicating the strength of the connection relationships through the conditional probability.

Optionally, on the basis of the causal relationship network structure, the SimpleEstimator algorithm is executed to generate the conditional probability table (CPT) of each indicator node. Among the indicator nodes, for any indicator node that has a parent indicator node, the conditional probability of the indicator node when its parent indicator node takes each of the possible values is obtained, so as to obtain a conditional probability table of the indicator node; for any indicator node that does not have a parent indicator node, the conditional probability table of the indicator node is determined according to the probability distribution (prior probability distribution) of the indicator node.

S205. obtaining Bayes Belief Networks, according to the causal relationship network structure and the conditional probability tables of each of the indicator node, to represent the causal relationships between each of the indicators.

In this embodiment, after obtaining the causal relationship network structure and the conditional probability tables of each of the indicator nodes, Bayes Belief Networks (BBN) of the directed acyclic graph can be spliced based on the causal relationship network structure and the conditional probability table of each indicator node, to represent causal relationships between each of the indicators. The Bayes Belief Networks takes indicators as nodes, which are connected through directed edges, wherein the directed edges between nodes represent mutual relationships between the indicator nodes (pointing from the parent indicator node to its child indicator node), conditional probabilities are used to express relationship strengthes, and the prior probability is used for information expression for those with no parent node.

On the basis of the Bayes belief networks, the Most Probable Explanation (MPE) that satisfies inference conditions can be solved according to the inference conditions and prior knowledge. For example, the prior knowledge may include the relationship between any two indicators. For example, if the CPU usage increases by 2%, then the memory usage increases by 10%, and if the CPU usage increases by 4%, then the memory usage increases by 30%. Based on this prior knowledge and the Bayes belief networks, the Most Probable Explanation of memory usage and other indicators can be inferred if the CPU usage increases by 6%, thus providing auxiliary information support for decision-making or fault root cause location.

The data processing method provided by this embodiment includes obtaining time series data of multiple indicators for which causal relationship is to be analyzed; clustering the multiple indicators according to probability distributions of the time series data of the multiple indicators, wherein indicators of the same category are indicators of independent identically distribution; analyzing causal connection relationships and connection directions between each of the indicators based on clustering result, and constructing a causal relationship network structure, the causal relationship network structure including indicator nodes and directed edges connecting the indicator nodes, the directed edges being used to represent causal relationships between connected indicator nodes; obtaining conditional probability tables of each of the indicator nodes in the causal relationship network structure according to the time series data of the multiple indicators; and obtaining Bayes belief networks according to the causal relationship network structure and the conditional probability tables of each of the indicator nodes, to represent the causal relationships between each of the indicators. The present embodiment can perform causal relationship discovery on high-dimensional time series data of multiple indicators, which expands applicable scenarios for causal relationship discovery, reduces computing costs, improves the efficiency of causal relationship discovery, and provides auxiliary information support for decision-making or fault root cause location.

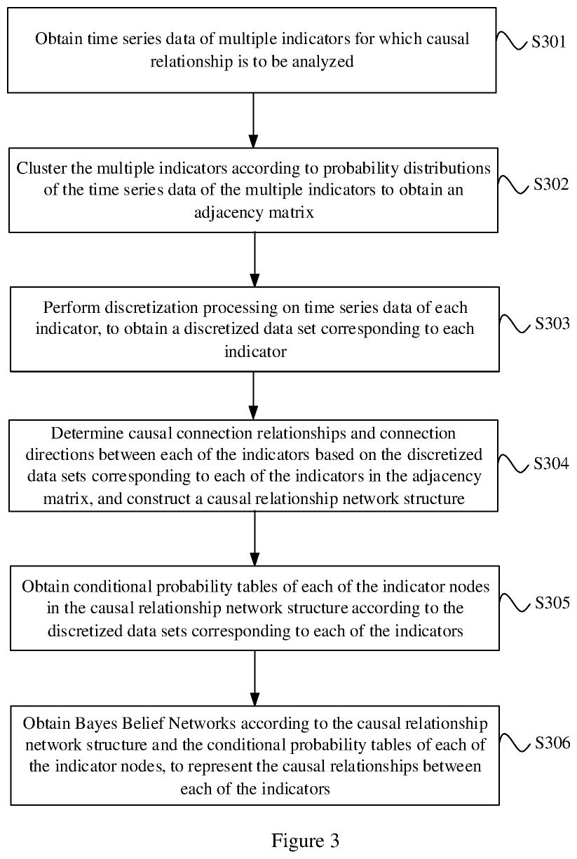

On the basis of the above embodiments, FIG. 3 is a schematic flowchart of a data processing method provided by an embodiment of the present disclosure. This data processing method comprises:

S301. obtaining time series data of multiple indicators for which causal relationship is to be analyzed.

In this embodiment, obtaining time series data of multiple indicators for which causal relationship is to be analyzed. This may refer to the above S201.

S302. clustering the multiple indicators according to probability distributions of the time series data of the multiple indicators to obtain an adjacency matrix.

In this embodiment, clustering the multiple indicators according to probability distributions of the time series data of the multiple indicators may refer to the above S202. Indicators with no causal correlation or weak correlation are eliminated, and indicators with strong correlation are found, so as to achieve dimension reduction, and the final clustering result is represented and stored in an adjacency matrix.

S303. performing discretization processing on time series data of each indicator, to obtain a discretized data set corresponding to each indicator.

In this embodiment, in view that the cost of constructing a causal relationship network structure by analyzing causal connections and connection directions between each of the indicators is very high, therefore, the time series data of each indicator can be discretized to reduce the cost of subsequent construction of a causal relationship network structure by analyzing causal connections and connection directions between each of the indicators. During the discretization process, since the time series data is continuous, different preset intervals can be configured for each indicator. For example, five preset intervals can be configured for a certain indicator, and the five preset intervals correspond to preset indicator values respectively. When the time series data of the indicator falls into one of the preset intervals, the time series data is replaced by the preset indicator value, thereby realizing discretization process to the time series data of the indicator and obtaining the discretized data sets of the indicators. Each indicator in the adjacency matrix undergoes the above discretization process to obtain a discretized data sets corresponding to each of the indicators in the adjacency matrix. In addition, a probability distribution of each indicator can be obtained according to the discretized data set corresponding to each indicator to provide support for the calculation of conditional probability tables.

S304. determining causal connection relationships and connection directions between each of the indicators based on the discretized data sets corresponding to each of the indicators in the adjacency matrix, and constructing a causal relationship network structure.

In this embodiment, on the basis of the discretized data sets corresponding to each of the indicator in the adjacency matrix, a causal structure discovery algorithm is used to determine the causal connection relationships and connection directions between each of the indicators, and construct a causal relationship network structure, which can greatly reduce costs and improve efficiency. The specific process may refer to S203.

Optionally, in this embodiment, a conditional independence testing method (such as the d/m-separation method) can be used to perform independence testing on each of the indicators in the adjacency matrix (an initial Acyclic Graph (DAG) or a Maximal Ancestral Graph (MAG) may be obtained according to the adjacency matrix), determine indicators of conditional independence of the Directed Acyclic Graph (DAG) or Maximal Ancestral Graph (MAG), and exclude the causal connection relationship between the indicators of conditional independence and other indicators, wherein, for the acyclic graph (DAG), the d-separation method can quickly determine whether two nodes are conditionally independent, and for the Maximal Ancestral Graph (MAG), the m-separation method can quickly determine whether two nodes are conditionally independent; and determine connection directions in causal connection relationships between each of the indicators according to the V-structure and Meek rules method, and finally obtain the directed acyclic graph (DAG) or the Maximal Ancestral Graph (MAG), which is determined as the causal relationship network structure.

S305. obtaining conditional probability tables of each of the indicator nodes in the causal relationship network structure according to the discretized data sets corresponding to each of the indicators.

In this embodiment, on the basis of the causal relationship network structure, the SimpleEstimator algorithm can be executed to generate the conditional probability tables (CPTs) of each of the indicator nodes. Among the indicator nodes, for any indicator node that has a parent indicator node, the conditional probability of the indicator node when its parent indicator node takes each of the possible values is obtained, to obtain conditional probability tables of the indicator node; for any indicator node that does not have a parent indicator node, the probability distribution (prior probability distribution) of the indicator node is obtained, and the conditional probability table of the indicator node is determined according to the probability distribution of the indicator node, wherein the probability distribution of the indicator node may be obtained according to the discretized data set corresponding to the indicator node.

S306. obtaining Bayes belief networks according to the causal relationship network structure and the conditional probability tables of each of the indicator nodes, to represent the causal relationships between each of the indicators.

In this embodiment, splicing the Bayes Belief Networks (BBN) of the directed acyclic graph may be referred to the above S205.

On the basis of any of the above embodiments, when analyzing causal connection relationships and connection directions between each of the indicators based on clustering result, and constructing a causal relationship network structure, in view that causal relationships between indicators may be synchronous, for example, in the same time window, indicator a fluctuates, and indicator b also fluctuates synchronously, in which case, causal connection relationships and connection directions between each of the indicators are analyzed based on time series data of each of the indicators in the same time window, constructing a causal relationship network structure, with each indicator corresponding to a node.

Specifically, when determining causal connection relationships and connection directions between each of the indicators based on the discretized data sets corresponding to each of the indicators in the adjacency matrix, and constructing a causal relationship network structure in S304, discrete data of each of the indicators in the adjacency matrix in the current time window may be first selected from the discretized data sets corresponding to each of the indicators to form first discretized data sets; the causal connection relationships and connection directions between each of the indicators are determined based on the first discretized data sets, and the causal relationship network structure is constructed.

In addition, there may also be a certain lag in the causal relationship between indicators. For example, indicator a fluctuates in the previous time window (t−1), and indicator b fluctuates just in the current time window (t), that is, there is a causal relationship between the indicator a in the previous time window (t−1) and the indicator b in the current time window (t). In this case, the causal connection relationships and connection directions between each of the indicators can be analyzed based on the time series data of each of the indicators in different time windows, and the causal relationship network structure is constructed, in which indicator analyzed in one time window corresponds to one node, while indicator analyzed in two time windows at the same time corresponds to two nodes, representing the indicator under the two time windows respectively.

Specifically, determining causal connection relationships and connection directions between each of the indicators based on the discretized data sets corresponding to each of the indicators in the adjacency matrix, and constructing a causal relationship network structure in S304, comprises:
selecting the discretized data of at least one first indicator(s) in the previous time window (t−1) from the discretized data sets corresponding to each of the indicators in the adjacency matrix to form second discretized data sets, and selecting the discretized data of at least one second indicators in the current time window (t) to form third discretized data sets; based on the second discretized data sets and the third discretized data sets, determining causal connection relationships and connection directions between each of the first indicator(s) in the previous time window (t−1) and each of the second indicator(s) in the current time window (t), and constructing a causal relationship network structure.

In this embodiment, the causal connection relationships and connection directions between each of the first indicators in the previous time window (t−1) and each of the second indicators in the current time window (t) can be analyzed through the above process, and in the constructed causal relationship network structure, the time window corresponding to each of the indicators may be identified. It should be noted that, if it is needed to analyze the causal connection relationships and connection directions between some indicators and other indicators in both of the previous time window (t−1) and the current time window (t), then the first indicators and the second indicators both include these indicators, that is, the first indicators and the second indicators in this embodiment may overlap. Through the causal structure discovery algorithm, the causal connection relationships and connection directions between the indicator and other indicators in the previous time window (t−1), as well as the causal connection relationships and connection directions between the indicator and other indicators in the current time window (t), can be analyzed. When constructing the causal relationship network structure, the indicator corresponds to two nodes, representing the indicator in the previous time window (t−1) and the indicator in the current time window (t) respectively, representing the causal connection relationships and connection directions between the indicator and other indicators in different time windows.

On the basis of any of the above embodiments, after obtaining the Bayes belief networks, it may further comprise:

S401. Obtaining inference conditions and prior knowledge of the relationship between any two of the indicators; wherein the inference conditions are values of part of the indicator nodes in the Bayes belief networks;

S402. obtaining the Most Probable Explanation that satisfies the inference conditions according to the prior knowledge and the Bayes belief networks, and determining values of another part of indicator nodes in the Bayes belief networks based on the Most Probable Explanation.

In this embodiment, at the stage of applying the Bayes belief networks, inference may be performed based on prior knowledge and the Bayes belief networks, wherein the inference condition can be that values of certain indicators are given. That is, given values of some indicators, values of other indicators are inferred based on the prior knowledge and the Bayes belief networks. For example, given a value of user concurrency of a network service (for example, the user concurrency increases by 3%) and the prior knowledge, which may be the known changing relationship between the server memory usage and the CPU usage (for example, if the memory usage increases by 4%, then the CPU usage increases by 2%), then it can be determined, based on the above prior knowledge and the Bayes belief networks, the Most Probable Explanation that satisfies the inference condition, that is, the predicted values of indicators such as server memory usage, CPU usage, and other indicators. Optionally, in this embodiment, the RPLoc algorithm may be used to infer and generate the Most Probable Explanation (MPE) based on the prior knowledge and Bayes Belief Networks.

Optionally, since the inference process takes a certain amount of time, the publish/subscribe (pub/sub) mode can be used to asynchronously obtain the Most Probable Explanation that satisfies inference conditions.

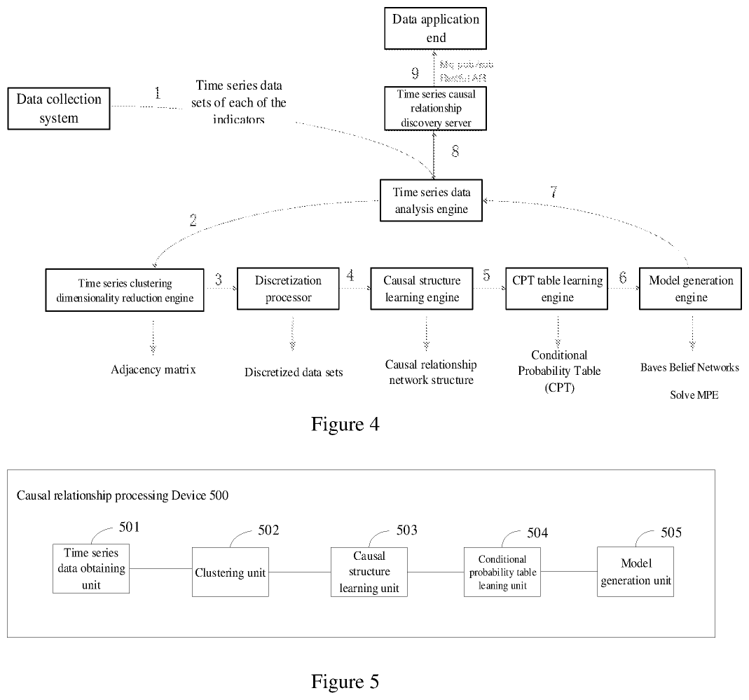

On the basis of any of the above embodiments, this embodiment further provides a data processing system architecture, as shown in FIG. 4. The system architecture includes a time series causal relationship discovery server, a time series data analysis engine, a time series clustering dimensionality reduction engine, a discretization processor, a causal structure learning engine, a CPT table learning engine and a model generation engine. Each part of the data processing system architecture can be arranged on the same server, or of course, can also be arranged on different servers. The time series data, the adjacency matrix, the discrete data sets, the causal relationship network structure, the conditional probability tables (CPTs), the Bayes belief networks, and the Most Probable Explanation (MPE) shown in FIG. 4 are only schematic diagrams.

Among the above components, the time series causal relationship discovery server: provides multiple ways of interaction (such as mq pub/sub asynchronous messaging or REStful API interface) for data applications, provides causal influence relationship retrieval and hypothesis condition reasoning services for the data application end, and may input reasoning conditions and prior knowledge of relationship between any two of the indicators by the time series causal relationship discovery server;
The time series data analysis engine: is used to interface with a third-party data collection system, receives a time series data set of each indicator, and creates a causal relationship discovery task according to a session request from the time series causal relationship discovery server;
The time series clustering dimensionality reduction engine: is used to receive the time-series data sets of each indicator of the causal relationship discovery task associated with the time series data analysis engine, executes a clustering dimensionality reduction algorithm, and outputs an adjacency matrix;
The discretization processor: is used to discretize the time series data sets corresponding to each of the indicators in the adjacency matrix according to specified parameters (preset interval) to obtain the discretized data sets corresponding to each of the indicators in the adjacency matrix;
The causal structure learning engine: executes a causal structure discovery algorithm and generates a causal relationship network structure based on the discretized data sets corresponding to each of the indicators in the adjacency matrix;
The CPT table learning engine: is used to execute the RPLoc algorithm to generate a conditional probability table (CPT) for each node in the causal relationship network structure based on the discretized data sets corresponding to each of the indicators in the adjacency matrix and the causal relationship network structure;
The model generation engine: is used to obtain the Bayes belief networks according to the causal relationship network structure and the conditional probability tables (CPTs) of each of the indicator nodes, can also be used to, according to inference conditions input by the time series causal relationship discovery server and prior knowledge, infer and generate the Most Probable Explanation (MPE), which is returned to the time series data analysis engine, through which in combination with the task, a final result set is generated and returned to the time series causal relationship discovery server, by which the final result set is then sent to the data application end that initiated the session.

Corresponding to the data processing method in the above embodiment, FIG. 5 is a structural block diagram of a data processing device provided by an embodiment of the present disclosure. For purposes of illustration, only parts related to the embodiments of the present disclosure are shown. Referring to FIG. 5, the data processing device 500 comprises: a time series data obtaining unit 501, a clustering unit 502, a causal structure learning unit 503, a conditional probability table learning unit 504, and a model generation unit 505.

Among these units, the time series data obtaining unit 501 is configured to obtain time series data of multiple indicators for which causal relationship is to be analyzed;

The clustering unit 502 is used to cluster the multiple indicators according to probability distributions of the time series data of the multiple indicators, wherein indicators of the same category are indicators of independent identically distribution;

The causal structure learning unit 503 is used to analyze causal connection relationships and connection directions between each of the indicators based on the clustering result, and construct a causal relationship network structure, the causal relationship network structure including indicator nodes and directed edges connecting the indicator nodes, the directed edges being used to represent causal relationships between connected indicator nodes;

The conditional probability table learning unit 504 is used to obtain conditional probability tables of each of the indicator nodes in the causal relationship network structure according to the time series data of the multiple indicators;

The model generation unit 505 is used to obtain Bayes belief networks according to the causal relationship network structure and the conditional probability tables of each of the indicator nodes, to represent the causal relationships between each of the indicators.

In one or more embodiments of the present disclosure, when the clustering unit 502 is clustering the multiple indicators according to the probability distributions of the time series data of the multiple indicators, the clustering unit 502 is used to:

obtain distances between each of the indicators according to the time series data of the multiple indicators, and determine the correlations between each of the indicator on the probability distribution according to the distances between the indicators, and obtain an adjacency matrix according to the correlations between each of the indicators, and use the adjacency matrix as the clustering result of the multiple indicators.

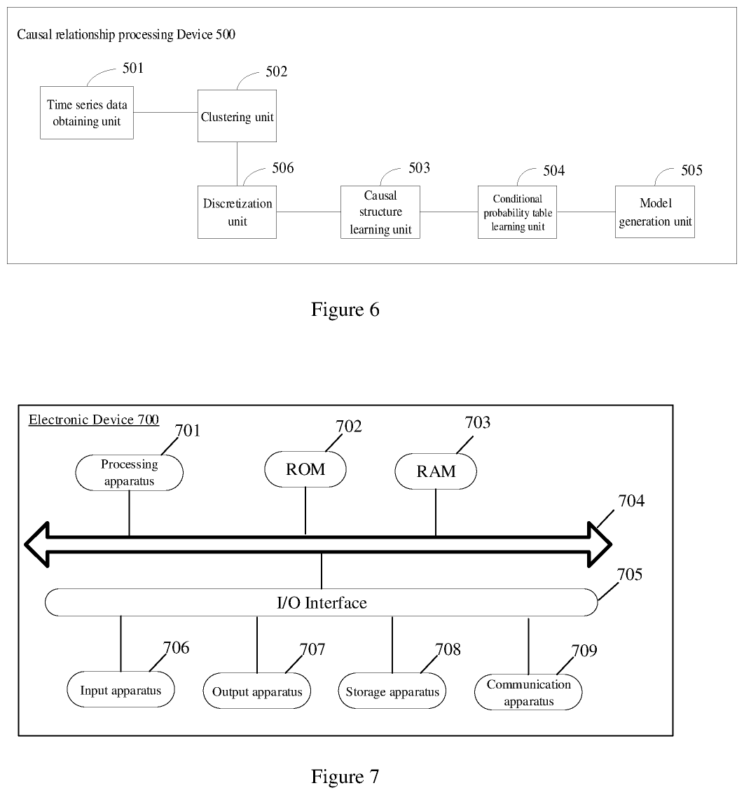

In one or more embodiments of the present disclosure, as shown in FIG. 6, the data processing device 500 further comprises a discretization unit 506 used to, after clustering the multiple indicators according to the probability distributions of the time series data of the multiple indicators, and before analyzing causal connection relationships and connection directions between each of the indicators based on the clustering result, discretize the time series data of each indicator to obtain a discretized data set corresponding to each indicator; the discretization unit 506 may also be used to obtain the probability distributions of each indicator according to the discretized data set corresponding to each indicator.

In one or more embodiments of the present disclosure, when the causal structure learning unit 503 is analyzing the causal connection relationships and connection directions between each of the indicators based on the clustering result, and constructing the causal relationship network structure, the causal structure learning unit 503 is used to:
determine the causal connection relationships and connection directions between each of the indicators based on the discretized data sets corresponding to each of the indicators in the adjacency matrix, and construct the causal relationship network structure.

In one or more embodiments of the present disclosure, when the causal structure learning unit 503 is determining the causal connection relationships and connection directions between each of the indicators, the causal structure learning unit 503 is used to:
perform independence test on each of the indicators in the adjacency matrix using a conditional independence testing method, to determine indicators of conditional independence and eliminate causal connection relationships between the indicators of conditional independence and other indicators, and determine connection directions in the causal connection relationships between each of the indicators according to the V-structure and Meek rules method to obtain a directed acyclic graph or a maximal ancestral graph, and determine the directed acyclic graph or the maximal ancestral graph as the causal relationship network structure.

In one or more embodiments of the present disclosure, when the causal structure learning unit 503 is determining the causal connection relationships and connection directions between each of the indicators according to the discretized data sets corresponding to each of the indicators in the adjacency matrix, and constructing the causal relationship network structure, the causal structure learning unit 503 is used to:
select, from the discretized data sets corresponding to each of the indicators in the adjacency matrix, first discretized data sets of each of the indicators in the current time window;
determine the causal connection relationships and connection directions between each of the indicators based on the first discretized data sets, and construct a causal relationship network structure.

In one or more embodiments of the present disclosure, when the causal structure learning unit 503 is determining the causal connection relationships and connection directions between each of the indicators based on the discretized data sets corresponding to each indicator in the adjacency matrix, and constructing the causal relationship network structure, the causal structure learning unit 503 is used to:
select, from the discretized data sets corresponding to each of the indicators in the adjacency matrix, second discretized data sets of at least one first indicators in the previous time window and third discretized data sets of at least one second indicators in the current time window;
determine, based on the second discretized data sets and the third discretized data sets, causal connection relationships and connection directions between each of the first indicators in the previous time window and each of the second indicators in the current time window, and construct a causal relationship network structure.

In one or more embodiments of the present disclosure, when the conditional probability table learning unit 504 is obtaining the conditional probability tables of each of the indicator nodes in the causal relationship network structure, the conditional probability table learning unit 504 is used to:
obtain, for any indicator node that has a parent indicator node, the conditional probability of the indicator node when its parent indicator node takes each of the possible values, to obtain a conditional probability table of the indicator node; or
obtain, for any indicator node that does not have a parent indicator node, the probability distribution of the indicator node, and determine the conditional probability table of the indicator node according to the probability distribution of the indicator node.

In one or more embodiments of the present disclosure, after the model generation unit 505 is obtaining the Bayes belief networks, the model generation unit 505 is further used to:
obtain inference conditions and prior knowledge of the relationship between any two of the indicators; wherein the inference conditions are the values of part of the indicator nodes in the Bayes belief networks;
obtain the Most Probable Explanation that satisfies the inference conditions according to the prior knowledge and the Bayes belief networks, and determine values of another part of the indicator nodes in the Bayes belief networks based on the Most Probable Explanation.

In one or more embodiments of the present disclosure, when the model generation unit 505 is obtaining the Most Probable Explanation that satisfies the inference conditions, the model generation unit 505 may obtain the Most Probable Explanation that satisfies the inference conditions asynchronously by using a publish/subscribe mode.

The device provided in this embodiment can be used to execute the technical solutions of the above method embodiments. Its implementation principles and technical effects are similar and will not be described again here in this embodiment.

Referring to FIG. 7, which shows a schematic structural diagram of an electronic device 700 suitable for implementing an embodiment of the present disclosure. The electronic device 700 may be a terminal device or a server. Among them, the terminal device may include but not limited to a mobile terminal such as a mobile phone, a laptop, a digital broadcast receiver, a Personal Digital Assistant (PDA), a Portable Android Device (PAD), a Portable Media Player (PMP), a vehicle-mounted terminal (for example, a vehicle-mounted navigation terminal), etc., and a fixed terminal such as a digital TV, a desktop computer, etc. The electronic device shown in FIG. 7 is only one example and should not impose any limitations on functions and scope of use of the embodiments of the present disclosure.

As shown in FIG. 7, the electronic device 700 may include a processing apparatus (for example, a central processing unit, a graphics processor, etc.) 701, which may execute various appropriate actions and processes according to a program stored in a Read Only Memory (ROM) 702 or loaded from the storage apparatus 708 into the Random Access Memory (RAM) 703. In the RAM 703, various programs and data required for operations of the electronic device 700 are also stored. The processing apparatus 701, the ROM 702 and the RAM 703 are connected to each other via a bus 704. An input/output (I/O) interface 705 is also connected to bus 704.

Generally, the following apparatuses may be connected to the I/O interface 705: an input apparatus 706 including, for example, a touch screen, a touch pad, a keyboard, a mouse, a camera, a microphone, an accelerometer, a gyroscope, etc.; an output apparatus 707 including, for example, a Liquid Crystal Display (LCD), a speaker, a vibrator, etc.; a storage apparatus 708 including, for example, a magnetic tape, a hard disk, etc.; and a communication apparatus 709. The communication apparatus 709 may allow electronic device 700 to perform wireless or wired communication with other devices to exchange data. Although FIG. 7 shows an electronic device 700 having various apparatuses, it should be understood that implementation or availability of all illustrated apparatuses is not required. More or fewer apparatuses may be implemented or provided alternatively.

In particular, according to the embodiments of the present disclosure, the processes described above with reference to the flowcharts may be implemented as computer software programs. For example, an embodiment of the present disclosure includes a computer program product, which includes a computer program carried on a computer-readable medium, and the computer program contains program code for executing the method shown in the flowchart. In such embodiments, the computer program may be downloaded and installed from the network via the communication apparatus 709, or installed from storage apparatus 708, or installed from the ROM 702. When the computer program is executed by the processing apparatus 701, the above functions defined in the methods of the embodiment of the present disclosure are executed.

It should be noted that above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of computer-readable storage media may include, but are not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program, and the program may be used by or in combination with an instruction execution system, apparatus, or device. In the present disclosure, a computer-readable signal medium may include a data signal propagated in a baseband or as a part of a carrier wave, in which a computer-readable program code is carried. This propagated data signal can take many forms, including but not limited to electromagnetic signals, optical signals, or any suitable combination thereof. The computer-readable signal medium may also be any computer-readable medium other than the computer-readable storage medium. The computer-readable signal medium may send, propagate, or transmit the program for use by or in combination with the instruction execution system, apparatus, or device. The program code contained on the computer-readable medium can be transmitted by any suitable medium, including but not limited to: electric wire, optical cable, RF (Radio Frequency), etc., or any suitable combinations thereof.

The above computer-readable medium may be included in above electronic devices; or it may exist alone without being assembled into the electronic devices.

The above computer-readable medium carries one or more programs thereon, which, when executed by the electronic device, cause the electronic device to perform the methods shown in the above embodiments.

The computer program code for performing the operations of the present disclosure can be written in one or more programming languages or a combination thereof. The above programming languages include object-oriented programming languages-such as Java, Smalltalk, C++, and also include conventional procedural programming languages-such as “C” language or similar programming languages. The program code can be executed entirely on a user's computer, partly executed on a user's computer, executed as an independent software package, partly executed on a user's computer and partly executed on a remote computer, or entirely executed on a remote computer or server. In the case of involving with a remote computer, the remote computer can be connected to a user's computer through any kind of network-including a Local Area Network (LAN) or a Wide Area Network (WAN), or it can be connected to an external computer (for example, connected via Internet provided by an Internet service provider).

The flowcharts and block diagrams in the accompanying drawings illustrate possible architecture, function, and operation implementations of a system, method, and computer program product according to various embodiments of the present disclosure. In this regard, each block in a flowchart or block diagram may represent a module, program segment, or part of code, which contains one or more executable instructions for realizing specified logic functions. It should also be noted that, in some alternative implementations, functions marked in a block may also occur in a different order than the order marked in the drawings. For example, two blocks shown in succession can actually be executed substantially in parallel, and they can sometimes be executed in the reverse order, depending on functions involved. It should also be noted that each block in a block diagram and/or flowchart, and the combination of blocks in a block diagram and/or flowchart, can be implemented by a dedicated hardware-based system that performs the specified functions or operations, or it can be implemented by a combination of dedicated hardware and computer instructions.

The units involved in the embodiments of the present disclosure can be implemented in software or hardware, wherein the name of the unit does not constitute a limitation on the unit itself under certain circumstances. For example, a first obtaining unit can also be described as “a unit that obtains at least two Internet Protocol addresses”.

The functions described herein above may be performed at least in part by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logical device (CPLD) and so on.

In the context of the present disclosure, a machine-readable medium may be a tangible medium, which may contain or store a program for use by the instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of machine-readable storage media may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In a first aspect, according to one or more embodiments of the present disclosure, there is provided a data processing method, comprising:
obtaining time series data of multiple indicators for which causal relationship is to be analyzed;
clustering the multiple indicators according to probability distributions of the time series data of the multiple indicators, wherein indicators of the same category are indicators of independent identically distribution;
analyzing causal connection relationships and connection directions between each of the indicators based on clustering result, and constructing a causal relationship network structure, the causal relationship network structure including indicator nodes and directed edges connecting the indicator nodes, the directed edges being used to represent causal relationships between connected indicator nodes;
obtaining conditional probability tables of each of the indicator nodes in the causal relationship network structure according to the time series data of the multiple indicators;
obtaining Bayes belief networks, according to the causal relationship network structure and the conditional probability tables of each of the indicator nodes, to represent the causal relationships between each of the indicators.

According to one or more embodiments of the present disclosure, the clustering the multiple indicators according to the probability distributions of the time series data of the multiple indicators comprises:
obtaining distances between each of the indicators according to the time series data of the multiple indicators, and determining the correlations between each of the indicator on the probability distribution according to the distances between the indicators, and obtaining an adjacency matrix according to the correlations between each of the indicators, and using the adjacency matrix as clustering result of the multiple indicators.

According to one or more embodiments of the present disclosure, after the clustering the multiple indicators according to the probability distributions of the time series data of the multiple indicators, and before the analyzing causal connection relationships and connection directions between each of the indicators based on the clustering result, further comprising:
discretizing the time series data of each indicator, to obtain a discretized data set corresponding to each indicator, and obtaining the probability distributions of each indicator according to the discretized data set corresponding to each indicator.

According to one or more embodiments of the present disclosure, the analyzing the causal connection relationships and connection directions between each of the indicators based on the clustering result and constructing a causal relationship network structure comprises:
determining the causal connection relationships and connection directions between each of the indicators based on the discretized data sets corresponding to each of the indicators in the adjacency matrix, and constructing the causal relationship network structure.

According to one or more embodiments of the present disclosure, the determining the causal connection relationships and connection directions between each of the indicators comprises:
performing independence test on each indicator in the adjacency matrix using a conditional independence testing method, to determine indicators of conditional independence and eliminate causal connection relationships between the indicators of conditional independence and other indicators, and determining connection directions in the causal connection relationships between each of the indicators according to the V-structure and Meek rules method to obtain a directed acyclic graph or a maximal ancestral graph, and determining the directed acyclic graph or the maximal ancestral graph as the causal relationship network structure.

According to one or more embodiments of the present disclosure, the determining the causal connection relationships and connection directions between each of the indicators based on the discretized data sets corresponding to each of the indicators in the adjacency matrix, and constructing a causal relationship network structure comprises:
selecting, from the discretized data sets corresponding to each of the indicators in the adjacency matrix, first discretized data sets of each of the indicators in the current time window;
determining the causal connection relationships and connection directions between each of the indicators based on the first discretized data sets, and constructing a causal relationship network structure.

According to one or more embodiments of the present disclosure, the determining the causal connection relationships and connection directions between each of the indicators based on the discretized data sets corresponding to each indicator in the adjacency matrix, and constructing a causal relationship network structure comprises:
selecting, from the discretized data sets corresponding to each of the indicators in the adjacency matrix, second discretized data sets of at least one first indicators in the previous time window and third discretized data sets of at least one second indicators in the current time window;
determining, based on the second discretized data sets and the third discretized data sets, causal connection relationships and connection directions between each of the first indicators in the previous time window and each of the second indicators in the current time window, and constructing a causal relationship network structure.

According to one or more embodiments of the present disclosure, the obtaining the conditional probability tables of each of the indicator nodes in the causal relationship network structure comprises:
Obtaining, for any indicator node that has a parent indicator node, the conditional probability of the indicator node when its parent indicator node takes each of the possible values, to obtain a conditional probability table of the indicator node; or
Obtaining, for any indicator node that does not have a parent indicator node, the probability distribution of the indicator node, and determining the conditional probability table of the indicator node according to the probability distribution of the indicator node.

According to one or more embodiments of the present disclosure, the obtaining the probability distribution of the indicator node comprises:
obtaining the probability distribution of the indicator node according to the discretized data sets corresponding to the indicator node.

According to one or more embodiments of the present disclosure, after the obtaining the Bayes belief networks, further comprising:
obtaining inference conditions and prior knowledge of the relationship between any two indicators; wherein the inference conditions are the values of part of the indicator nodes in the Bayes belief networks;
obtaining the Most Probable Explanation that satisfies the inference conditions according to the prior knowledge and the Bayes belief networks, and determining values of another part of the indicator nodes in the Bayes belief networks based on the Most Probable Explanation.

According to one or more embodiments of the present disclosure, the obtaining the Most Probable Explanation that satisfies the inference conditions comprises:
obtaining the Most Probable Explanation that satisfies the inference conditions asynchronously by using a publish/subscribe mode.

In a second aspect, according to one or more embodiments of the present disclosure, there is provided a data processing device, comprising:
a time series data obtaining unit for obtaining time series data of multiple indicators for which causal relationship is to be analyzed;
a clustering unit for clustering the multiple indicators according to probability distributions of the time series data of the multiple indicators, wherein indicators of the same category are indicators of independent identically distribution;
a causal structure learning unit for analyzing causal connection relationships and connection directions between each of the indicators based on clustering result, and constructing a causal relationship network structure, the causal relationship network structure including indicator nodes and directed edges connecting the indicator nodes, the directed edges being used to represent causal relationships between connected indicator nodes;
a conditional probability table learning unit for obtaining conditional probability tables of each of the indicator nodes in the causal relationship network structure according to the time series data of the multiple indicators;
a model generation unit for obtaining Bayes belief networks according to the causal relationship network structure and the conditional probability tables of each of the indicator nodes, to represent the causal relationships between each of the indicators.

According to one or more embodiments of the present disclosure, when clustering the multiple indicators according to the probability distributions of the time series data of the multiple indicators, the clustering unit is used to:
obtain distances between each of the indicators according to the time series data of the multiple indicators, and determine the correlations between each of the indicator on the probability distribution according to the distances between the indicators, and obtain an adjacency matrix according to the correlations between each of the indicators, and use the adjacency matrix as the clustering result of the multiple indicators.

According to one or more embodiments of the present disclosure, the device further comprises a discretization unit for, after clustering the multiple indicators according to the probability distributions of the time series data of the multiple indicators, and before analyzing causal connection relationships and connection directions between each of the indicators based on the clustering result, discretizing the time series data of each indicator, to obtain a discretized data set corresponding to each indicator; and obtain the probability distributions of each indicator according to the discretized data set corresponding to each indicator.

According to one or more embodiments of the present disclosure, when analyzing the causal connection relationships and connection directions between each of the indicators based on the clustering result, and constructing the causal relationship network structure, the causal structure learning unit is used to:
determine the causal connection relationships and connection directions between each of the indicators based on the discretized data sets corresponding to each of the indicators in the adjacency matrix, and construct the causal relationship network structure.

According to one or more embodiments of the present disclosure, when determining the causal connection relationships and connection directions between each of the indicators, the causal structure learning unit is used to:
perform independence test on each of the indicators in the adjacency matrix using a conditional independence testing method, to determine indicators of conditional independence and eliminate causal connection relationships between the indicators of conditional independence and other indicators, and determine connection directions in the causal connection relationships between each of the indicators according to the V-structure and Meek rules method to obtain a directed acyclic graph or a maximal ancestral graph, and determine the directed acyclic graph or the maximal ancestral graph as the causal relationship network structure.

According to one or more embodiments of the present disclosure, when determining the causal connection relationships and connection directions between each of the indicators according to the discretized data sets corresponding to each of the indicators in the adjacency matrix, and constructing the causal relationship network structure, the causal structure learning unit is used to:
select, from the discretized data sets corresponding to each of the indicators in the adjacency matrix, first discretized data sets of each of the indicators in the current time window;
determine the causal connection relationships and connection directions between each of the indicators based on the first discretized data sets, and construct a causal relationship network structure.

According to one or more embodiments of the present disclosure, when determining the causal connection relationships and connection directions between each of the indicators based on the discretized data sets corresponding to each of the indicators in the adjacency matrix, and constructing the causal relationship network structure, the causal structure learning unit is used to:
select, from the discretized data sets corresponding to each of the indicators in the adjacency matrix, second discretized data sets of at least one first indicators in the previous time window and third discretized data sets of at least one second indicators in the current time window;
determine, based on the second discretized data sets and the third discretized data sets, causal connection relationships and connection directions between each of the first indicators in the previous time window and each of the second indicators in the current time window, and construct a causal relationship network structure.

According to one or more embodiments of the present disclosure, when obtaining the conditional probability tables of each of the indicator nodes in the causal relationship network structure, the conditional probability table learning unit is used to:
obtain, for any indicator node that has a parent indicator node, the conditional probability of the indicator node when its parent indicator node takes each of the possible values, to obtain a conditional probability table of the indicator node; or
obtain, for any indicator node that does not have a parent indicator node, the probability distribution of the indicator node, and determine the conditional probability table of the indicator node according to the probability distribution of the indicator node.

According to one or more embodiments of the present disclosure, when obtaining the probability distribution of the indicator node, the conditional probability table learning unit is used to:
obtain the probability distribution of the indicator node according to the discretized data set corresponding to the indicator node.

According to one or more embodiments of the present disclosure, after obtaining the Bayes belief networks, the model generation unit is further used to:
obtain inference conditions and prior knowledge of the relationship between any two indicators; wherein the inference conditions are the values of part of the indicator nodes in the Bayes belief networks;
obtain the Most Probable Explanation that satisfies the inference conditions according to the prior knowledge and the Bayes belief networks, and determine values of another part of the indicator nodes in the Bayes belief networks based on the Most Probable Explanation.

According to one or more embodiments of the present disclosure, when obtaining the Most Probable Explanation that satisfies the inference conditions, the model generation unit can obtain the Most Probable Explanation that satisfies the inference conditions asynchronously by using a publish/subscribe mode.

In a third aspect, according to one or more embodiments of the present disclosure, there is provided an electronic device, comprising: at least one processor and a memory;
the memory having computer executable instructions stored thereon;
the at least one processor executing the computer executable instructions stored in the memory, causing the at least one processor to execute the data processing method according to the above first aspect and various possible designs of the first aspect.

In a fourth aspect, according to one or more embodiments of the present disclosure, there is provided a computer-readable storage medium having computer executable instructions stored thereon, which, when executed by a processor, implement the data processing method according to the above first aspect and various possible designs of the first aspect.

In a fifth aspect, according to one or more embodiments of the present disclosure, there is provided a computer program product including computer executable instructions, which, when executed by a processor, implement the data processing method according to the above first aspect and various possible designs of the first aspect.

The above description is only preferred embodiments of the present disclosure and an explanation to the technical principles applied. Those skilled in the art should understand that the scope of disclosure involved in this disclosure is not limited to technical solutions formed by specific combination of above technical features, and should also cover other technical solutions formed by arbitrarily combining the above technical features or equivalent features thereof without departing from above disclosed concept. For example, those technical solutions formed by exchanging of above features and technical features disclosed in the present disclosure (but not limited to) having similar functions with each other.

In addition, although various operations are depicted in a specific order, this should not be understood as requiring these operations to be performed in the specific order shown or performed in a sequential order. Under certain circumstances, multitasking and parallel processing may be advantageous. Likewise, although several specific implementation details are included in above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable sub-combination.

Although the subject matter has been described in a language specific to structural features and/or logical actions of the method, it should be understood that the subject matter defined in the appended claims is not necessarily limited to the specific features or actions described above. Rather, the specific features and actions described above are merely exemplary forms for implementing the claims.

What is claimed is:

1. A data processing method, comprising:
obtaining time series data of multiple indicators, for which causal relationship is to be analyzed;
clustering the multiple indicators according to probability distributions of the time series data of the multiple indicators, wherein indicators of the same category are indicators of independent identically distribution;
analyzing causal connection relationships and connection directions between each of the indicators based on the clustering result, and constructing a causal relationship network structure, the causal relationship network structure including indicator nodes and directed edges connecting the indicator nodes, the directed edges being used to represent causal relationships between the connected indicator nodes;
obtaining conditional probability tables of each of the indicator nodes in the causal relationship network structure according to the time series data of the multiple indicators;
obtaining Bayes Belief Networks, according to the causal relationship network structure and the conditional probability tables of each of the indicator nodes, to represent the causal relationships between each of the indicators.

2. The method according to claim 1, wherein the clustering the multiple indicators according to probability distributions of the time series data of the multiple indicators comprises:
obtaining distances between each of the indicators according to the time series data of the multiple indicators, determining the correlations between each of the indicators on the probability distribution according to the distances between the indicators, obtaining an adjacency matrix according to the correlations between each of the indicators, and using the adjacency matrix as clustering result of the multiple indicators.

3. The method according to claim 2, wherein the method further comprises: after the clustering the multiple indicators according to the probability distributions of the time series data of the multiple indicators, and before the analyzing causal connection relationships and connection directions between each of the indicators based on the clustering result,
discretizing the time series data of each indicator to obtain a discretized data set corresponding to each indicator;
the analyzing the causal connection relationships and connection directions between each of the indicators based on the clustering result, and constructing a causal relationship network structure comprising:
determining the causal connection relationships and connection directions between each of the indicators based on the discretized data sets corresponding to each indicator in the adjacency matrix, and constructing the causal relationship network structure.

4. The method according to claim 3, wherein the determining the causal connection relationships and connection directions between each of the indicators comprises:
performing independence test on each of the indicator in the adjacency matrix using a conditional independence testing method, determining indicators with conditional independence and eliminating causal connection relationships between the indicators with conditional independence and other indicators, and determining connection directions in the causal connection relationships between each of the indicator according to V-Structure and Meek Rules method to obtain a directed acyclic graph or a maximal ancestral graph, and determining the directed acyclic graph or the maximal ancestral graph as the causal relationship network structure.

5. The method according to claim 4, wherein the determining the causal connection relationships and connection directions between each of the indicators based on the discretized data sets corresponding to each of the indicators in the adjacency matrix, and constructing a causal relationship network structure comprises:
selecting, from the discretized data sets corresponding to each of the indicators in the adjacency matrix, first discretized data sets of each of the indicators in the current time window;
determining the causal connection relationships and connection directions between each of the indicators based on the first discretized data sets, and constructing a causal relationship network structure.

6. The method according to claim 4, wherein the determining the causal connection relationships and connection directions between each of the indicators based on the discretized data sets corresponding to each of the indicators in the adjacency matrix, and constructing a causal relationship network structure comprises:
selecting, from the discretized data sets corresponding to each of the indicators in the adjacency matrix, second discretized data sets of at least one first indicators in the previous time window and third discretized data sets of at least one second indicators in the current time window;
determining, based on the second discretized data sets and the third discretized data sets, causal connection relationships and connection directions between each of the first indicators in the previous time window and each of the second indicators in the current time window, and constructing a causal relationship network structure.

7. The method according to claim 3, wherein the obtaining the conditional probability tables of each of the indicator nodes in the causal relationship network structure comprises:
obtaining, for any indicator node that has a parent indicator node, a conditional probability of the indicator node when its parent indicator node takes each of possible values, to obtain the conditional probability table of the indicator node; or
obtaining, for any indicator node that does not have a parent indicator node, the probability distribution of the indicator node, and determining the conditional probability table of the indicator node according to the probability distribution of the indicator node.

8. The method according to claim 1, further comprising: after the obtaining the Bayes Belief Networks,
obtaining inference conditions and prior knowledge of the relationships between any two indicators; wherein the inference conditions are the values of part of the indicator nodes in the Bayes Belief Networks;
obtaining the Most Probable Explanation that satisfies the inference conditions according to the prior knowledge and the Bayes Belief Networks, and determining values of another part of the indicator nodes in the Bayes Belief Networks based on the Most Probable Explanation.

9. The method according to claim 8, wherein the obtaining the Most Probable Explanation that satisfies the inference conditions comprises:
obtaining the Most Probable Explanation that satisfies the inference conditions asynchronously by using a publish/subscribe mode.

10. An electronic device, comprising: at least one processor and a memory;
the memory having computer executable instructions stored thereon;
the at least one processor executing the computer executable instructions stored in the memory, causing the at least one processor to execute a data processing method comprising:
obtaining time series data of multiple indicators, for which causal relationship is to be analyzed;
clustering the multiple indicators according to probability distributions of the time series data of the multiple indicators, wherein indicators of the same category are indicators of independent identically distribution;
analyzing causal connection relationships and connection directions between each of the indicators based on the clustering result, and constructing a causal relationship network structure, the causal relationship network structure including indicator nodes and directed edges connecting the indicator nodes, the directed edges being used to represent causal relationships between the connected indicator nodes;
obtaining conditional probability tables of each of the indicator nodes in the causal relationship network structure according to the time series data of the multiple indicators;
obtaining Bayes Belief Networks, according to the causal relationship network structure and the conditional probability tables of each of the indicator nodes, to represent the causal relationships between each of the indicators.

11. The electronic device according to claim 10, wherein the clustering the multiple indicators according to probability distributions of the time series data of the multiple indicators comprises:
obtaining distances between each of the indicators according to the time series data of the multiple indicators, determining the correlations between each of the indicators on the probability distribution according to the distances between the indicators, obtaining an adjacency matrix according to the correlations between each of the indicators, and using the adjacency matrix as clustering result of the multiple indicators.

12. The electronic device according to claim 11, wherein the method further comprises: after the clustering the multiple indicators according to the probability distributions of the time series data of the multiple indicators, and before the analyzing causal connection relationships and connection directions between each of the indicators based on the clustering result,
discretizing the time series data of each indicator to obtain a discretized data set corresponding to each indicator;
the analyzing the causal connection relationships and connection directions between each of the indicators based on the clustering result, and constructing a causal relationship network structure comprising:
determining the causal connection relationships and connection directions between each of the indicators based on the discretized data sets corresponding to each indicator in the adjacency matrix, and constructing the causal relationship network structure.

13. The electronic device according to claim 12, wherein the determining the causal connection relationships and connection directions between each of the indicators comprises:
performing independence test on each of the indicator in the adjacency matrix using a conditional independence testing method, determining indicators with conditional independence and eliminating causal connection relationships between the indicators with conditional independence and other indicators, and determining connection directions in the causal connection relationships between each of the indicator according to V-Structure and Meek Rules method to obtain a directed acyclic graph or a maximal ancestral graph, and determining the directed acyclic graph or the maximal ancestral graph as the causal relationship network structure.

14. The electronic device according to claim 13, wherein the determining the causal connection relationships and connection directions between each of the indicators based on the discretized data sets corresponding to each of the indicators in the adjacency matrix, and constructing a causal relationship network structure comprises:
selecting, from the discretized data sets corresponding to each of the indicators in the adjacency matrix, first discretized data sets of each of the indicators in the current time window;
determining the causal connection relationships and connection directions between each of the indicators based on the first discretized data sets, and constructing a causal relationship network structure.

15. The electronic device according to claim 13, wherein the determining the causal connection relationships and connection directions between each of the indicators based on the discretized data sets corresponding to each of the indicators in the adjacency matrix, and constructing a causal relationship network structure comprises:
selecting, from the discretized data sets corresponding to each of the indicators in the adjacency matrix, second discretized data sets of at least one first indicators in the previous time window and third discretized data sets of at least one second indicators in the current time window;
determining, based on the second discretized data sets and the third discretized data sets, causal connection relationships and connection directions between each of the first indicators in the previous time window and each of the second indicators in the current time window, and constructing a causal relationship network structure.

16. A non-transitory computer-readable storage medium, wherein the computer-readable storage medium has computer executable instructions stored thereon, which, when executed by a processor, implement a data processing method comprising:
obtaining time series data of multiple indicators, for which causal relationship is to be analyzed;
clustering the multiple indicators according to probability distributions of the time series data of the multiple indicators, wherein indicators of the same category are indicators of independent identically distribution;
analyzing causal connection relationships and connection directions between each of the indicators based on the clustering result, and constructing a causal relationship network structure, the causal relationship network structure including indicator nodes and directed edges connecting the indicator nodes, the directed edges being used to represent causal relationships between the connected indicator nodes;
obtaining conditional probability tables of each of the indicator nodes in the causal relationship network structure according to the time series data of the multiple indicators;
obtaining Bayes Belief Networks, according to the causal relationship network structure and the conditional probability tables of each of the indicator nodes, to represent the causal relationships between each of the indicators.

17. The non-transitory computer-readable storage medium according to claim 16, wherein the clustering the multiple indicators according to probability distributions of the time series data of the multiple indicators comprises:
obtaining distances between each of the indicators according to the time series data of the multiple indicators, determining the correlations between each of the indicators on the probability distribution according to the distances between the indicators, obtaining an adjacency matrix according to the correlations between each of the indicators, and using the adjacency matrix as clustering result of the multiple indicators.

18. The non-transitory computer-readable storage medium according to claim 17, wherein the method further comprises: after the clustering the multiple indicators according to the probability distributions of the time series data of the multiple indicators, and before the analyzing causal connection relationships and connection directions between each of the indicators based on the clustering result,
discretizing the time series data of each indicator to obtain a discretized data set corresponding to each indicator;
the analyzing the causal connection relationships and connection directions between each of the indicators based on the clustering result, and constructing a causal relationship network structure comprising:
determining the causal connection relationships and connection directions between each of the indicators based on the discretized data sets corresponding to each indicator in the adjacency matrix, and constructing the causal relationship network structure.

19. The non-transitory computer-readable storage medium according to claim 18, wherein the determining the causal connection relationships and connection directions between each of the indicators comprises:
performing independence test on each of the indicator in the adjacency matrix using a conditional independence testing method, determining indicators with conditional independence and eliminating causal connection relationships between the indicators with conditional independence and other indicators, and determining connection directions in the causal connection relationships between each of the indicator according to V-Structure and Meek Rules method to obtain a directed acyclic graph or a maximal ancestral graph, and determining the directed acyclic graph or the maximal ancestral graph as the causal relationship network structure.

20. The non-transitory computer-readable storage medium according to claim 19, wherein the determining the causal connection relationships and connection directions between each of the indicators based on the discretized data sets corresponding to each of the indicators in the adjacency matrix, and constructing a causal relationship network structure comprises:
selecting, from the discretized data sets corresponding to each of the indicators in the adjacency matrix, first discretized data sets of each of the indicators in the current time window;
determining the causal connection relationships and connection directions between each of the indicators based on the first discretized data sets, and constructing a causal relationship network structure.
